(19) United States
(12) Patent Application Publication
(10) Pub. No.: US 2020/0175562 A1
(43) Pub. Date: Jun. 4, 2020

(54) GEM TRADE AND EXCHANGE SYSTEM AND PREVIOUS-BLOCK VERIFICATION METHOD FOR BLOCK CHAIN TRANSACTIONS

(71) Applicant: Krisada Somsri, Ubon Ratchathan (TH)

(72) Inventor: Krisada Somsri, Ubon Ratchathan (TH)

(21) Appl. No.: 16/209,507

(22) Filed: Dec. 4, 2018

(51) Int. Cl. G06Q 30/06; G06Q 30/02; G06Q 20/06; G06Q 20/38; H04L 9/06

(52) U.S. Cl. CPC G06Q 30/0613; G06Q 30/0278; G06Q 20/0655; H04L 2209/56; H04L 9/0637; H04L 2209/38; G06Q 20/389

(57) ABSTRACT

A gem trade and exchange system and previous-block verification method for block chain transactions features deposits of gems and gem information to the central trade and exchange system functioning as a bank-level service providing agency or organization. Service users deposit gems to the central trade and exchange system or service users deposit gems to the central trade and exchange system for reliability certification. Transactions related to said gems are conducted using block chain currencies, wherein previous blocks in block chain transactions are verified by said central trade and exchange system, the previous block in the chain, and independent operators who receive transaction information.

### BRANCH OF SCIENCE ASSOCIATED WITH THE INVENTION

Gem trade and exchange system and previous-block verification method for block chain transactions.

Computer engineering in parts related to the Gem trade and exchange system and previous-block verification method for block chain transactions.

### BACKGROUND OF RELATED ART OR SCIENCE

Block chain technology is a new technology utilized in digital currencies through electronic cash systems.

The block chain technology provides data structures for storing transactions and can be used as an account for sorting electronic forms responsible for recording transactions involving personal identification codes and destination identifiers. Transactions are contained in blocks and every block (except for the first block) can be traced back or linked to previous blocks in the chain.

Computer nodes store block chains in addition to encryptions (cryptographically), verify each new block and allow all transactions between related blocks to be recorded from source to destination to ensure public verification. This process of verification is known as “transaction evidence”.

Integrity such as confidence that previously recorded transactions have not been modified by the block chain remains intact because each block contains records that allow verification of previous blocks.

As a result, previous blocks cannot be easily modified or interfered by information such as having their recorded transactions changed. This is because even slight changes in data cause values to change throughout the entire chain. In addition, new blocks make it more difficult to modify older content. Therefore, although the contents of a block chain might appear readily available for use by all parties to which they are visible, they cannot be modified in practice.

Block chain transaction identifiers are created by encryption such as public key encryption. For example, a user can create a destination identifier based on a personal key. The relationship between private keys and destination identifiers can later be used to provide “evidence” to parties with connected transactions created. In other words, users can create new transactions to “spend” the contents of the previous transactions. Because the relationships between destination identifiers and related private keys are only known to an undisclosed number of users, many destination identifiers can be created, being linked only through their private keys.

Therefore, the overall relationship between users and numerous transactions contained in a block chain could be concealed from other users. Even if transaction details are exposed to the public in an account that categorizes transactions, transaction participants can remain concealed because identifiers are linked to private keys known only to the participants.

Although block chain technology has the potential for new features, it carries with it significant problems relating to calculations and time required in order to verify previous blocks, it may require a high-performance computer and may take up to several days for each verification. For example, the first block chain has 1,000,000 baht made up of five blocks of 200,000 baht each.

Block A has 200,000 baht.

Block B has 200,000 baht.

Block C has 200,000 baht.

Block D has 200,000 baht.

Block E has 200,000 baht.

A simple verification process is uniformly used, i.e., verification of all previous transactions. For example:

Block A transfers 100,000 baht to Block B.

Block B transfers 50,000 baht to Block C.

Block C transfers 40,000 baht to Block D.

Block D transfers 30,000 baht to Block E.

Block E transfers 20,000 baht to Block F.

The latest transaction occurring between Block E and Block F containing 20,000 baht will be complete only once its previous transaction has been verified. This means that

Block A has to verify that 100,000 baht has been transferred to Block B.

Block B has to verify that 50,000 baht has been transferred to Block C.

Block C has to verify that 40,000 baht has been transferred to Block D.

Block D has to verify that 30,000 baht has been transferred to Block E.

This verification of previous blocks can require computers with high processing power and could take several days. The reason is because there are no limits to the number of additional blocks and there can be hundreds of millions, billions, tens of billions or even trillions of previous blocks to be verified. This situation poses a challenge in verifying the accuracy of previous blocks. Even if the verification time of previous blocks is sufficiently shortened, it is still guaranteed that changes are impractical and that several days will still be required due to the need for safety and prevention of malicious computer access aimed at applying changes to this complicated system.

Hence, a major problem of the block chain system is the slow process of previous-block verification and the need to have powerful computer systems for performing calculations.

The block chain system has been adopted for the international gem trade and exchange system. Traditionally, the methods of trade and exchange of gems are simple, with purchases and sales made online being made through an intermediary. Service providers communicate with service users through the intermediary or directly to negotiate trade and exchanges, and transactions are made by using regular currencies. The drawback of these methods is that international gem trade and exchanges lack a central agency for verifying and certifying the accuracy or reliability of the sources of gems that are traded. Moreover, currencies used in these transactions might have untrustworthy sources and be at risk of being connected to money laundering.

Therefore, this invention provides a gem trade and exchange system and previous-block verification method for block chain transactions. It consists of depositing gems to a central trade and exchange system, which is a bank-level service providing agency or organization. The central trade and exchange system functions as the medium in gem trade and exchanges and the central gem trade and exchange system handles acceptance and spending of block chain currencies and performs verification of previous blocks in block chain transactions.

The special feature is that it has a process for gem trade and exchanges involving the following conditions for acquiring block chain currencies:

Condition 1: Service users will deposit gems to the central trade and exchange system and the central trade and exchange system will appraise the value of these gems and give trade and exchange prices in block chain currencies. The gems will be stored at the central gem trade and exchange system.

Condition 2: Service users deposit gems into the central trade and exchange system for reliability certification. If a service user would like a block chain currency, a regular currency has to be used to purchase the block chain currency.

The previous-block verification method for block chain transactions involves verification by one or more of the following:

a. A central trade and exchange functioning as a reliable gem bank.

b. A service user receiving the first block chain currencies from the central trade and exchange system functioning as a reliable gem bank.

c. Previous service users who have paid in block chain currencies in previous financial transactions.

d. Independent operators (admins) receive transaction information from the central trade and exchange system functioning as a reliable gem bank that receives transaction information from the service user who sent it. Independent operators (admins) have codes that cannot be practically accessed or guessed to verify block chain transactions. There is an odd number of independent operators (admins) operating in different locations and independent operators (admins) cannot access one another.

### INVENTION CHARACTERISTICS AND OBJECTIVES

Gem trade and exchange system and previous-block verification method for block chain transactions consisting of the following:

Depositing gems to the central trade and exchange system, which is a bank-level service providing agency or organization. The central trade and exchange system functions as the medium in gem trade and exchanges and the central gem trade and exchange system handles acceptance and spending of block chain currencies and performs verification of previous blocks in block chain transactions.

The special feature is that it has a process for gem trade and exchanges involving the following conditions for acquiring block chain currencies:

Condition 1: Service users will deposit gems to the central trade and exchange system and the central trade and exchange system will appraise the value of these gems and award block chain currencies in exchange for trading at the central gem trade and exchange system.

Condition 2: Service users deposit gems into the central trade and exchange system for reliability certification. If a service user would like a block chain currency, a regular currency has to be used to purchase the block chain currency.

Conditions 1 and 2 provide gem information for the system.

By Condition 1, gems are stored at the central trade and exchange system.

By Condition 2, gems are stored with service users but gem information is stored at the central trade and exchange system.

The previous-block verification method for block chain transactions involves verification by one or more of the following:

a. A central trade and exchange functioning as a reliable gem bank.

b. A service user receiving the first block chain currencies from the central trade and exchange system functioning as a reliable gem bank.

c. Previous service users who paid in block chain currencies in previous financial transactions.

d. Independent operators (admins) receive transaction information from the central trade and exchange system functioning as a reliable gem bank that receives transaction information from the service user who sent it. Independent operators (admins) have codes that cannot be practically accessed or guessed to verify block chain transactions. There is an odd number of independent operators (admins) operating in different locations and independent operators (admins) cannot access one another.

### BRIEF DESCRIPTION OF DIAGRAMS

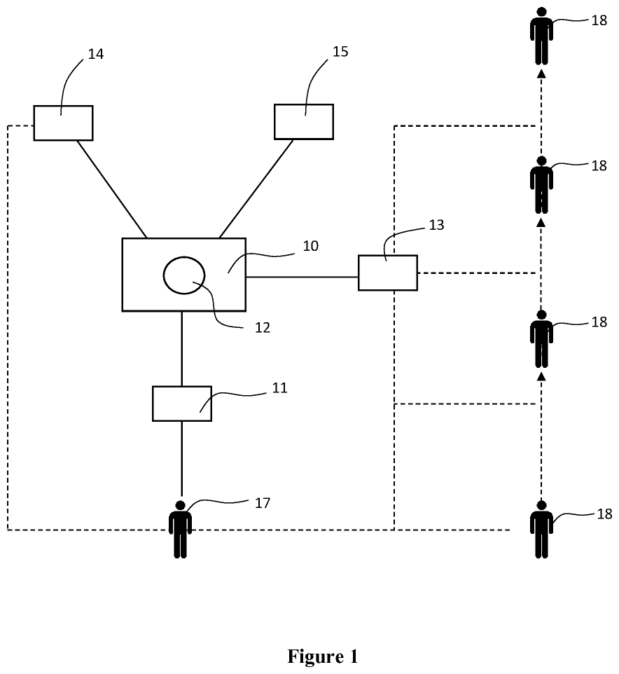

FIG. 1 shows a diagram of the gem trade and exchange system and previous-block verification method for block chain transactions in this invention.

### FULL DISCLOSURE OF THE INVENTION

FIG. 1 shows a diagram of the gem trade and exchange system and previous-block verification method for block chain transactions.

Featuring the following:

Depositing gems to the central trade and exchange system (10), which is a bank-level service providing agency or organization. The central trade and exchange system (10) functions as the medium in gem trade and exchanges and the central gem trade and exchange system handles acceptance and spending of block chain currencies (14) and performs verification of previous blocks in block chain transactions.

There is a process for gem trade and exchanges involving the following conditions for acquiring block chain currencies (14):

Condition 1: Service users 1 (17) will deposit gems (11) to the central trade and exchange system (10) and the central trade and exchange system (10) will appraise the value of these gems (11) and award block chain currencies (14) in exchange for trading at the central gem trade and exchange system (11).

Condition 2: Service users 1 (17) deposit gems (11) into the central trade and exchange system (10) for reliability certification (15). If a Service users 1 (17) would like a block chain currency, a regular currency has to be used to purchase the block chain currency.

Conditions 1 and 2 provide gem information (12) to the system. In Condition 1, gems are stored at the central trade and exchange system (10).

In Condition 2, gems (11) are stored with service users but gem information (12) is stored at the central trade and exchange system (10).

The central trade and exchange system (10) functions as a gathering place of information and products in international gem (11) trade and exchanges. Transactions are made by using block chain currencies (14).

Block chain currencies (14) are spent for the first time from the central trade and exchange system (10) functioning as a reliable gem bank. Block chain currencies (14) have unique block chain codes for each currency unit. Block chain currency codes cannot be practically accessed or guessed. Block chain currencies (14) are used in gem trade and exchanges (11).

The previous-block verification method for block chain transactions involves verification by one or more of the following:

a. The central trade and exchange system (10) functioning as a reliable gem bank.

b. A Service users 1 (17) receiving the first block chain currencies (14) from the central trade and exchange system (10) functioning as a reliable gem bank.

c. Previous service users 2 (18) who paid in block chain currencies (14) in previous financial transactions.

d. Independent operators (admins) (13) receive transaction information from the central trade and exchange system (10) functioning as a reliable gem bank that receives transaction information from the service user 1 (17) and the service user 2 (18) who sent it. Independent operators (admins) (13) have codes that cannot be practically accessed or guessed to verify block chain transactions. There is an odd number of independent operators (admins) (13) operating in different locations and independent operators (admins) (13) cannot access one another.

Transactions take place, for example, as follows:

Service User A deposits gems (11) to the central trade and exchange system (10). The central trade and exchange system (10) will appraise the value of A's gems and award block chain currencies (14) in exchange for trading gems (11) at the central trade and exchange system (10). Block chain currencies (14) paid to A for the first time is paid by the central trade and exchange system (10) functioning as a reliable gem bank. Block chain currencies (14) have unique block chain codes for each currency unit. Block chain currency codes cannot be practically accessed or guessed. Block chain currencies (14) are used in gem trade and exchanges (11). In this example, Service User A deposited gems (11) to the central trade and exchange system (10) and the central trade and exchange system (10) awarded 200,000 units of a block chain currency.

Service User B deposits gems (11) to the central trade and exchange system (10) for reliability certification (15). B would like to have a block chain currency for trading gems (11) in the central trade and exchange system (10). Therefore, B uses a regular currency such as the Thai baht (THB) or US dollars (USD) to purchase a block chain currency from the central trade and exchange system (10). In this example, Service User B used the Thai baht (THB) or (USD) to purchase a block chain currency and the central trade and exchange system (10) granted 200,000 units of a block chain currency to the service user.

Service User C deposits gems (11) to the central trade and exchange system (10). The central trade and exchange system (10) then appraises the value of C's gems (11) and awards a block chain currency in exchange for trading gems (11) in the central trade and exchange system (10). The block chain currency first paid to C is paid by the central trade and exchange system (10) functioning as a reliable gem bank. Block chain currencies (14) have unique block chain codes for each currency unit. Block chain currency codes cannot be practically accessed or guessed. Block chain currencies (14) are used in gem trade and exchanges (11). In this example, Service User C deposited gems (11) to the central trade and exchange system (10) and the central trade and exchange system (10) awarded 200,000 units of a block chain currency.

A's transaction is elaborated upon as follows:

A has 200,000 units.

A would like to purchase gems (11) from B and B would like to sell the equivalent of 100,000 units.

A transfers 100,000 units to B.

A's transaction will be verified by the central trade and exchange system.

Every verification by the central trade and exchange system (10) of block chain transactions increases the reliability of block chain codes, shows that block chain codes are certifiably authentic and indicate the reliability of block chain currencies (14), e.g., A has 100,000 units under the code 12345.

Once A's transaction is verified by the central trade and exchange system, A's 100,000 units will contain the code 123456. The number 6 that is added indicates the increased reliability of the block chain currency.

As for the transaction between B and C, verification will also be by the central trade and exchange system (10) and B's 100,000 units will then have the code 1234567, where the added number seven indicates the increased reliability of the block chain currency.

These additions can be in the form of unlimited changes, increases and decreases to numeric or character or symbol codes. In any case, changes indicate certification of the code by the central trade and exchange system.

B received 100,000 units from A.

B transferred 100,000 units to C to purchase gems (11) from C.

B's transaction will be verified by the central trade and exchange system (10) and verified by A, the initial owner of the funds. Transactions repeatedly verified by the central trade and exchange system (10) have maximum block chain code reliability and, therefore, do not need to be verified by the initial owner of the funds such as A or other service users who have paid in block chain currencies (14) in previous transactions.

Transactions made in blocks after A, which is the initial owner of the funds, such as when B transfers 100,000 units to C, cause information to be sent to independent operators (admins) (13). Independent operators (admins) (13) receive this information from B and the central trade and exchange system (10). Independent operators (admins) (13) exist in odd numbers such as 3, 5, 7, 9, 11, etc., e.g., Independent Operator 1 (Admin 1), Independent Operator 2 (Admin 2), independent Operator 3 (Admin 3), etc. The Independent operators (admins) (13) existing in odd numbers are responsible for verifying previous blocks in order to authorize transactions in destination blocks.

Independent operators (admins) (13) existing in odd numbers enter private keys to verify previous blocks in order to authorize transactions in destination blocks. A large number of independent operators (admins) (13) are required to authorize transactions in destination blocks.

Independent operators (admins) (13) existing in odd numbers are able to identify destinations using private keys. Otherwise, Independent operators (admins) (13) existing in odd numbers are unable to identify destinations by using private keys.

Independent operators (13) know block chain transaction routes in parallel with block chain transactions made by service users.

For example:

A has 200,000 units.

A transfers 100,000 units to B.

B has 200,000 units.

B transfers 100,000 units to C.

C has 200,000 units.

C transfers 100,000 units to D.

D has 200,000 units.

D transfers 100,000 units to E.

The transactions made from B to D will be verified by the central trade and exchange system (10) and A, the initial owner of the funds, or other service users who paid block chain currencies (14) in previous transactions in addition to independent operators (admins) (13) existing in odd numbers.

The transaction made from C to D will be verified by the central trade and exchange system (10) in addition to B and independent operators (admins) (13) existing in odd numbers without any request for verification by A, the initial owner of the funds.

The transaction from D to E will be verified by the central trade and exchange system (10) in addition to C and independent operators (admins) (13) existing in odd numbers without any request for verification by A, the initial owner of the funds.

Independent operators (13) know block chain transaction routes such as from A to E in parallel with block chain transactions made by service users.

Blocks can increase without limit and there can eventually be hundreds of millions, billions, tens of billions or even trillions of previous blocks without limit. The aforementioned conditions allow previous blocks to be verified easily and quickly and become impractical to change.

In this model, a single transaction route was raised as an example. However, this type of model can involve vast numbers. For example, there might be up to a million people in A with several different branches and segments.

1. A method for gem trade and exchange using previous-block verification for block chain transactions comprising the steps of:
Depositing, by an initial owner of funds, one or more gems to a central trade and exchange system;
appraising, by said central trade and exchange system, the value of said one or more gems;
awarding, by said central trade and exchange system, one or more block chain currencies based on said value of said one or more gems;
conduct transactions related to said one or more gems using said one or more block chain currencies;
wherein each transaction sends information to independent operators that maintain a record of each block chain transaction;
wherein the first transaction is verified by said central trade and exchange system, said initial owner of funds, and said independent operators; and
wherein every subsequent transaction is verified by said central trade and exchange system, the previous block, and said independent operators.

2. The method for gem trade and exchange using previous-block verification for block chain transactions of claim 1, wherein block chain codes can be changed without limits in the form of increases and decreases to numeric, character or symbol codes.

3. The method for gem trade and exchange using previous-block verification for block chain transactions of claim 1, wherein said independent operators identify destinations using private keys.

4. The method for gem trade and exchange using previous-block verification for block chain transactions of claim 1, wherein said independent operators are in different locations and cannot access one another.

5. A method for gem trade and exchange using previous-block verification for block chain transactions comprising the steps of:
Depositing, by an initial owner of funds, one or more gems to a central trade and exchange system;
appraising, by said central trade and exchange system, the value of said one or more gems;
purchasing, with regular currencies, one or more block chain currencies based on said value of said one or more gems;
conduct transactions related to said one or more gems using said one or more block chain currencies;
wherein each transaction sends information to independent operators that maintain a record of each block chain transaction;
wherein the first transaction is verified by said central trade and exchange system, said initial owner of funds, and said independent operators; and
wherein every subsequent transaction is verified by said central trade and exchange system, the previous block, and said independent operators.

6. The method for gem trade and exchange using previous-block verification for block chain transactions of claim 5, wherein block chain codes can be changed without limits in the form of increases and decreases to numeric, character or symbol codes.

7. The method for gem trade and exchange using previous-block verification for block chain transactions of claim 5, wherein said independent operators identify destinations using private keys.

8. The method for gem trade and exchange using previous-block verification for block chain transactions of claim 5, wherein said independent operators are in different locations and cannot access one another.
